(19) United States
(12) Patent Application Publication
(10) Pub. No.: US 2010/0109465 A1
(43) Pub. Date: May 6, 2010

(54) MOTOR STRUCTURE AND FAN

(75) Inventors: Shih-Jen Yang, Taipei (TW); Yung-Sheng Wu, Taipei (TW); Hung-Sen Tu, Taipei (TW); I-Hsing Chen, Taipei (TW); Chen-Chia Yang, Taipei (TW)

Correspondence Address: PEARNE & GORDON LLP, 1801 EAST 9TH STREET, SUITE 1200, CLEVELAND, OH, 44114-3108, US

(73) Assignee: SYSTEM GENERAL CORPORATION, Taipei (TW)

(21) Appl. No.: 12/393,131

(22) Filed: Feb. 26, 2009

(30) Foreign Application Priority Data
Oct. 30, 2008 (TW) 97141730

(51) Int. Cl. H02K 21/22; H02K 11/00; F04D 25/08

(52) U.S. Cl. 310/156.12; 310/68 B; 417/423.7

(57) ABSTRACT

A motor structure and a fan are provided. The motor structure includes a shaft, a motor control panel, a stator, a rotor and a motor housing. The motor control panel has a first fastening portion and is engageable with the shaft. The stator has a second fastening portion coupled to the first fastening portion so as to fasten the motor control panel to the stator, thereby reducing the overall size and saving costs of materials. The rotor corresponds in position to the stator and is pivotally connected to the shaft. The motor housing is pivotally connected to the shaft and encloses the shaft, the motor control panel, the stator, and the rotor. The fan includes the motor structure and a fan blade element.

### BACKGROUND OF THE INVENTION

1. Field of the Invention

The present invention relates generally to motor structures and fans, and more particularly to an outer rotor type brushless DC motor structure and a fan with the motor structure.

2. Description of Related Art

A motor converts electric energy into mechanical energy so as to provide rotary motion and essentially comprises a stator and a rotor. The electric energy is supplied to the motor to induce an electromagnetic field between the stator and the rotor. The electromagnetic field produces attraction/repulsion to generate mechanical energy, thereby enabling rotation of the rotor. In addition to providing rotary motion directly, a motor converts rotary mechanical energy into various mechanical motions, such as linear motion and vibrating motion, by a combination of mechanisms. Generally, there are three types of motors according to power sources, namely DC motors, AC motors, and brushless DC (BLDC) motors.

Regarding a conventional DC motor, the stator is formed from permanent magnets, and the rotor is enclosed with a field winding and provided with a commutator in physical contact with carbon brushes of different polarity so as to transmit DC power to the field winding, thereby generating an electromagnetic force. The attraction/repulsion between the electromagnetic force and the permanent magnets of the stator causes the rotor to rotate. The commutator rotates along with the rotor and thereby changes the brushes in physical contact while rotating. This enables alternation of the direction of current, and in consequence the rotor continues to turn in the same direction. However, mechanical commutation unnecessarily wastes energy due to mechanical friction. In addition, sparks and noises are easily generated on the contact surface between the commutator and the brushes. Furthermore, a maintenance cost is incurred as a result of cleanup and replacement of the brushes.

The rotor of an AC motor is formed from permanent magnets, and a field winding is wound on the stator, wherein alternating current is transmitted into the field winding for generating a magnetic field which alternates between opposite directions. Such an AC motor spares the use of any commutator or brushes and accordingly is free of the above-described drawbacks of a DC motor. However, it is difficult to change the speed of an AC motor, because both AC frequency and AC voltage need to be modulated.

Unlike the above-described DC and AC motor, a BLDC motor operates by electronic commutation. Specifically speaking, the rotor of a BLDC motor is formed by permanent magnets, and a field winding is wound around the stator as in an AC motor. By changing the current input direction of the field winding, the direction of the electromagnetic force can be changed to keep the rotor rotating. Hence, a BLDC motor spares the use of brushes and accordingly overcome the drawbacks caused by the brushes. In addition, compared with an AC motor, the control operation of such a BLDC motor is simpler. Therefore, BLDC motors are widely applied in the industry.

The electronic commutation control method needs to detect polarity of the magnetic field corresponding to the position of the rotor for precisely controlling the direction of the electromagnetic force. Therefore, a controller is indispensable to a BLDC motor. For example, U.S. Pat. No. 7,157,872 discloses a ceiling fan with an outer rotor type BLDC motor. The BLDC motor comprises a controller, a stator, and a rotor, wherein the controller is connected to a group of magnetism sensors corresponding in position to induction magnets disposed on the periphery outer surface of the rotor, so as to indirectly detect polarity of the permanent magnets of the rotor through the induction magnets and thereby drive the rotor to continuously rotate in the same direction. However, with the controller being above the motor housing (that is, outside the motor housing) and additional induction magnets being provided for the motor housing so as for the sensors to detect variation of magnetic field, conduction lines have to extend from inside of the motor housing to the outside of the motor housing for connecting the controller, which inevitably complicates the whole structure and increases the overall size and the material cost. The induction magnets also complicate the whole structure and increase the overall size.

Accordingly, Taiwan Patent No. M315782 and No. M320603 propose technique whereby a sensing element is fixed in position to a fan, wherein a motor comprises a stator formed from a shaft and silicon steel sheets, a rotor, a sensing element, and a circuit board. The silicon steel sheets have a predetermined receiving slot for receiving and positioning the sensing element. However, with both the circuit board and the sensing element being positioned on the periphery of the stator according to the technique, a dispensing process is required to prevent detachment of the sensing element from the circuit board, which accordingly complicates the fabrication process.

Therefore, there is a need to provide a motor structure and a fan to overcome the above-described drawbacks.

### SUMMARY OF THE INVENTION

Accordingly, an objective of the present invention to provide a motor structure and a fan which are structurally simple and are easy to fabricate.

Another objective of the present invention is to provide a motor structure and a fan which are downsized by using less components.

A further objective of the present invention is to provide a motor structure and a fan so as to reduce the material cost.

In order to attain the above and other objectives, the present invention provides a motor structure, which comprises: a shaft; a motor control panel having a first fastening portion and engageable with the shaft; a stator having a second fastening portion corresponding in position to the first fastening portion, wherein the second fastening portion is coupled with the first fastening portion so as to fasten the motor control panel to the stator; a rotor corresponding in position to the stator and pivotally connected to the shaft; and a motor housing pivotally connected to the shaft, enclosing the shaft, the motor control panel, the stator, and the rotor.

To attain the above and other objectives, the present invention further provides a fan comprising a fan blade element with a plurality of blades and a motor structure, wherein the motor structure comprises: a shaft; a motor control panel having a first fastening portion and configured for connection with a power source; a stator engageable with the shaft and comprising a base body engageable with the shaft and having a plurality of excitation units and a fastening base disposed on one side of the base body facing the motor control panel, the fastening base having a second fastening portion corresponding in position to the first fastening portion for coupling with the second fastening portion so as to fasten the motor control panel to the stator; a rotor corresponding in position to the stator and pivotally connected to the shaft and connected to the fan blade element, the rotor having a predetermined number of magnet units corresponding in number to the excitation units; and a motor housing pivotally connected to the shaft, enclosing the shaft, the motor control panel, the stator, and the rotor. Therein, when the motor control panel is connected to a power source, electric power is distributed to each of the excitation units so as to generate an induced magnetic field for creating attraction and repulsion between the excitation units and the magnet units, and in consequence the rotor drives the fan blade element to rotate.

In the present invention, a first fastening portion is disposed on the motor control panel and a second fastening portion corresponding in position to the first fastening portion is disposed on the stator such that the motor control panel can be fastened to the stator through coupling of the first and second fastening portions. Accordingly, not only the motor control panel is disposed inside the motor structure, but it is not necessary to provide a receiving slot on silicon steel sheets or perform a dispensing process as in the prior art. Therefore, the motor structure and the fan using the motor structure of the present invention are simple and easy to fabricate. Further, the induction magnets as in the prior art are not needed in the present invention and the conductive lines of the present invention do not have to extend to the outside of the motor housing for electrically connecting a controller as in the prior art, thereby reducing the overall size of the motor structure and saving the material cost.

### BRIEF DESCRIPTION OF DRAWINGS

FIG. 1 is an exploded view of a motor structure according to the present invention;

FIG. 2 is an assembly view of the motor structure according to the present invention;

FIG. 3 is a sectional view of the motor structure according to the present invention;

FIG. 4 is an exploded view of a fan with the motor structure; and

FIG. 5 is an exploded view of the motor structure, viewed from another angle.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

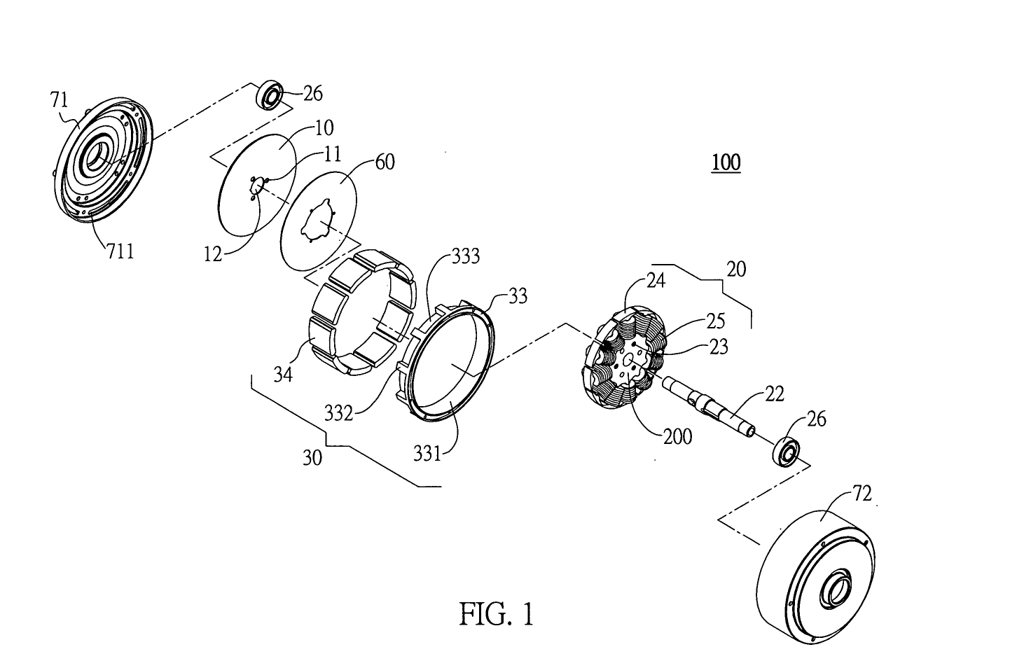

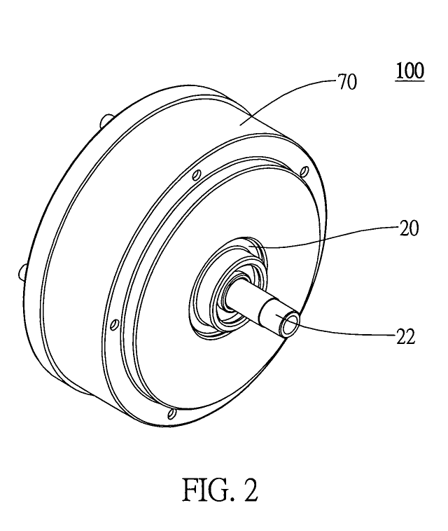

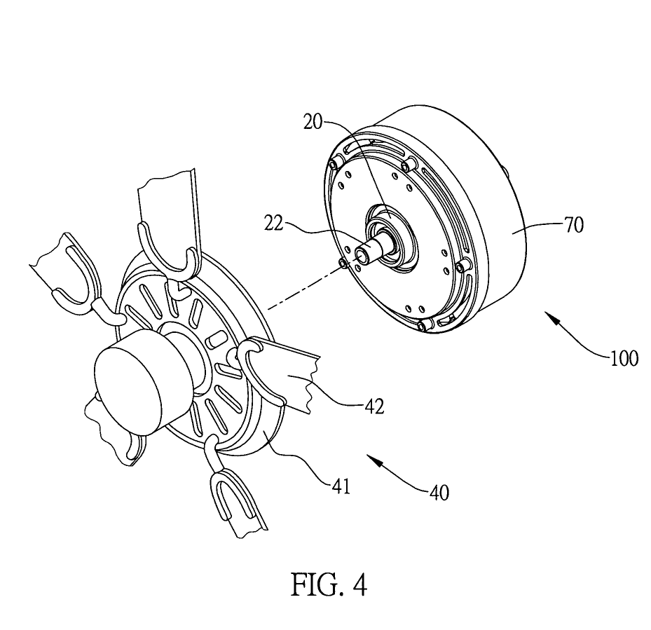

FIGS. 1 to 5 are different views illustrating a motor structure according to the present invention. As shown in the drawings, the motor structure 100 of the present invention comprises a motor control panel 10, a stator 20, a rotor 30, a shaft 22, bearings 26, a shield plate 60, and a motor housing. The motor structure 100 is an outer-rotor type brushless DC motor (BLDC). The rotor 30 rotates around the stator 20 so as to cause the fan 40 to rotate around the stator 20, as shown in FIG. 4. The fan 40 may be a ceiling fan or other fan devices. The components of the motor structure are detailed as follows.

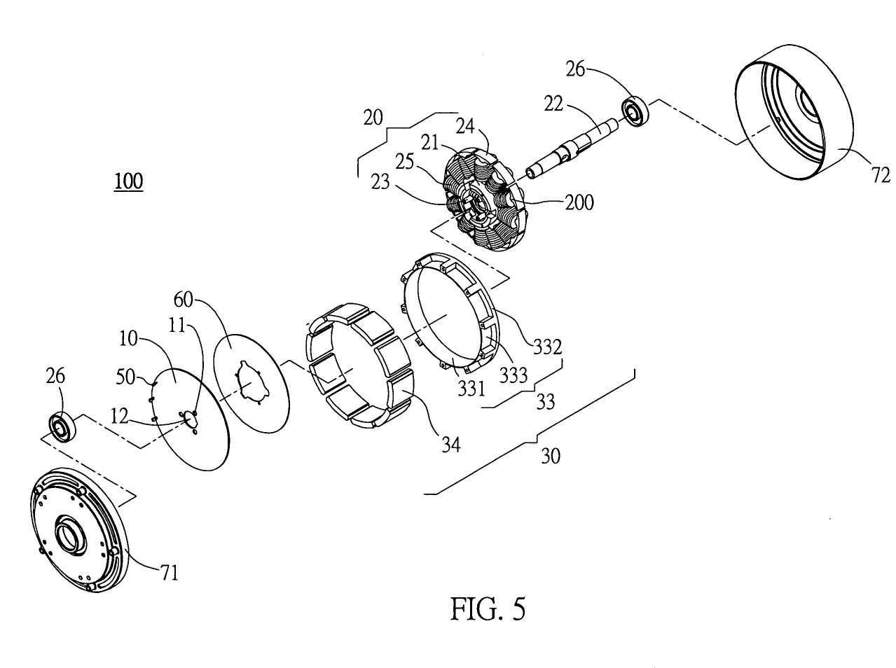

The motor control panel 10 comprises a first fastening portion 11 and a shaft hole 12 for receiving the shaft 22 therethrough. The stator 20 engages the shaft 22. The stator 20 comprises: a base body 200, a fastening base 21 disposed on one side of the base body 200 facing the motor control panel 10 (as shown in FIG. 5), and a plurality of excitation units 25. The base body 200 is formed by stacking and series-connecting a plurality of metal sheets such as silicon steel sheets. The fastening base 21 is a metal base disposed on one side of the base body 200 facing the motor control panel 10. The fastening base 21 has a second fastening portion 23 corresponding in position to the first fastening portion 11. Through coupling of the first fastening portion 11 and the second fastening portion 23, the motor control panel 10 is firmly fastened to the base body 200 of the stator 20. The rotor 30 corresponds in position to the stator 20 and is pivotally connected to the shaft 22. In particular, the first fastening portion 11 is a hole, and the second fastening portion 23 is a stud or has a block-like structure, such that the motor control panel 10 can be fastened to the stator 20 through screwing of the stud (the second fastening portion 23) into the hole (the first fastening portion 11). Of course, the numbers, positions and sizes of the holes and the studs are not limited to the present embodiment. In other embodiments, the first fastening portion 11 is a stud, and the second fastening portion 23 is a hole. In addition, other structures may be applied to couple the first fastening portion 11 and the second fastening portion 23 together.

A predetermined number of excitation units 25 are disposed around the base body 200 of the stator 20 and electrically connected to the motor control panel 10. The rotor 30 has a predetermined number of magnet units 34 corresponding to the predetermined number of excitation units 25.

The motor housing comprises a first housing 71 and a second housing 72. The first housing 71 and the second housing 72 are pivotally connected to the shaft 22 and enclose the shaft 22, the motor control panel 10, the stator 20, and the rotor 30. The stator 20 is pivotally connected to the shaft 22 through two bearings 26 disposed at two ends of the shaft 22, and the two bearings 26 are further disposed in the shaft holes of the first housing 71 and the second housing 72 respectively. The rotor 30 further comprises a fastening frame 33 disposed inside the first housing 71 and the second housing 72 and has an inner wall 331 and an outer wall 332, wherein the inner wall 331 encircles the periphery of the base body 200 of the stator 20 and the predetermined number of magnet units 34 are evenly disposed on the outer wall 332. Thus, the magnet units 34 and the excitation units 25 are spaced from each other. Further, the first housing 71 has an engaging slot 711 for receiving and engaging with one end of each of the magnet units 34. Upon connection with a power source, the motor control panel 10 distributes electric power to each of the excitation units 25, allowing the excitation units 25 to generate an induced magnetic field for creating attraction and repulsion relative to the magnet units 34, thereby driving the rotor 30 to rotate.

In the above-described embodiment, the excitation units 25 are coils windingly disposed in a ring-shaped slot (not shown) of the base body 200. The magnet units 34 comprise permanent magnets. The numbers, positions and sizes of the magnet units 34 are not limited. But in principle, the magnet units 34 are disposed in slots 333 around the fastening frame 33 and arranged with magnetic poles of opposite polarity located adjacent one another and extending to positions capable of inducting with the excitation units 25. It is well known in the art that the excitation coils, the permanent magnets, and the stacked and series-connected silicon steel sheets together form the base body 200 of the stator 20; hence, detailed description thereof is omitted herein.

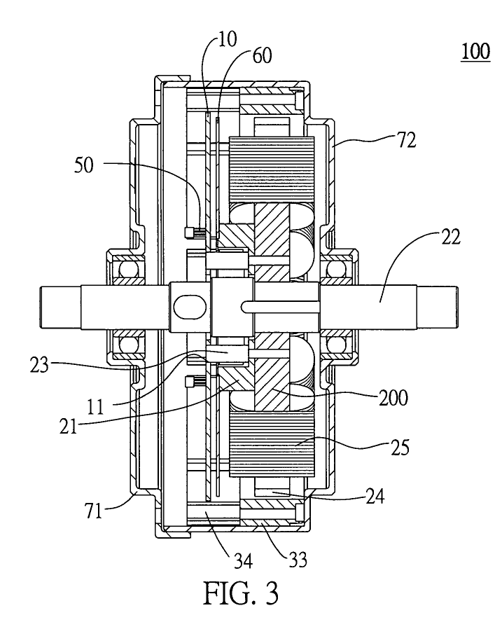

FIG. 4 shows a fan with the motor structure according to the present invention. As shown in the drawing, the fan 40 of the present invention is a ceiling fan, which comprises: a fan blade element 41 with a plurality of blades 42, and a motor structure 100. The motor structure 100 comprises the motor control panel 10, the stator 20, the rotor 30, the shaft 22, the bearings 26, the shield plate 60 and the motor housing 70 as shown in FIG. 3. The fan blade element 41 is disposed on the first housing 71 of the motor structure. The fan blade element concentrically corresponds in position to the stator 20 and is pivotally connected to the shaft 22. Since the predetermined number of excitation units 25 are disposed around the stator 20 and electrically connected to the motor control panel 10 and the predetermined number of magnet unit 34 are disposed on the rotor 30 corresponding in position to the excitation units 25, when the motor control panel 10 is connected to the power source, electric power is distributed to each of the excitation units 25 so as to generate an induced magnetic field creating attraction and repulsion between the excitation units 25 and the magnet units 34, thereby causing the rotor 30 to rotate along with the first housing 71 and the fan blade element 41 disposed on the first housing 71. Since the essential features of the motor structure of the present embodiment are similar to the above-described embodiment, detailed description thereof is omitted herein.

FIG. 5 shows the motor structure viewed from another angle. As shown in the drawing, a sensor element 50 is further disposed on the motor control panel 10, which can be such as a Hall element for detecting direction of the magnetic field so as to determine polarity and position of the rotor 30. It should be noted that the position of the sensor element 50 on the motor control panel 10 is not limited to the present embodiment, but the sensor element 50 should be disposed at a non-shielding area capable of sensing the magnet units 34. That is, sizes, shapes and positions of the magnet units 34 should be designed such that the magnet units 34 can be sensed by the sensor element. Compared with the prior art, since the sensor element 50 is disposed on the motor control panel 10 in the present invention instead of the fastening base 21 (made from silicon steel sheets), the present invention doesn't need dispensing process, simplifies the whole structure, and facilitates the assembling process. In addition, since the motor structure 100 comprises a shield plate 60 disposed between the motor control panel 10 and the stator 20 so as to shield magnetic fields generated by the excitation units 25 and isolate high voltage, better electrical performance can be achieved.

Therefore, according to the present invention, a first fastening portion is disposed on the motor control panel and a second fastening portion corresponding in position to the first fastening portion is disposed on the stator such that the motor control panel can be fastened to the stator through coupling of the first and second fastening portions. Accordingly, not only the motor control panel is disposed inside the motor structure, but also the needs of a receiving slot disposed on silicon steel sheets and a dispensing process as in the prior art are eliminated. Therefore, the motor structure and the fan using the motor structure of the present invention are simple and easy to fabricate. Further, the induction magnets as in the prior art are not needed in the present invention and the conductive lines of the present invention do not need to extend to the outside of the motor housing for electrically connecting a controller as in the prior art, thereby reducing the overall size of the motor structure and saving the material cost. Furthermore, the shield plate disposed between the motor control plate and the stator provides better electrical performance. Moreover, by disposing the sensor element on the motor control panel instead of the base body of the stator, the whole structure is simplified and the assembling process is facilitated. Therefore, the motor structure and the fan with the motor structure of the present invention overcome the conventional drawbacks and have high industrial application value.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A motor structure, comprising:
a shaft;
a motor control panel comprising a first fastening portion and engageable with the shaft;
a stator having a second fastening portion corresponding in position to the first fastening portion, wherein the second fastening portion is coupled with the first fastening portion so as to fasten the motor control panel to the stator;
a rotor corresponding in position to the stator and pivotally connected to the shaft; and
a motor housing pivotally connected to the shaft and enclosing the shaft, the motor control panel, the stator, and the rotor.

2. The motor structure of claim 1, wherein the stator comprises:
a base body engageable with the shaft; and
a fastening base disposed on a side of the base body facing the motor control panel, the fastening base comprising the second fastening portion.

3. The motor structure of claim 2, wherein the fastening base is a metal base.

4. The motor structure of claim 2, wherein a predetermined number of excitation units are disposed around the base body of the stator and electrically connected to the motor control panel, and the rotor has a predetermined number of magnet units corresponding to the predetermined number of excitation units.

5. The motor structure of claim 4, wherein the excitation units are disposed in a ring-shaped slot of the base body.

6. The motor structure of claim 4, wherein the excitation units are coils.

7. The motor structure of claim 4, wherein the motor housing further comprises an engaging slot for receiving and engaging with one end of each of the magnet units.

8. The motor structure of claim 4, wherein the rotor further comprises a fastening frame disposed inside the motor housing and having an inner wall and an outer wall, the inner wall encircling the periphery of the stator, and the magnet units being disposed on the outer wall.

9. The motor structure of claim 8, further comprising a sensor element disposed at the motor control panel of the motor, and the magnet units disposed on the outer wall of the fastening frame are of sizes, shapes, and positions allowing the magnet units to be sensed by the sensor element.

10. The motor structure of claim 9, wherein the sensor element is a Hall element.

11. The motor structure of claim 4, wherein the magnet units are permanent magnets.

12. The motor structure of claim 1, further comprising a shield plate disposed between the motor control panel and the stator for shielding magnetic fields generated by the excitation units and isolating high voltage.

13. The motor structure of claim 1, wherein the first fastening portion is a hole and the second fastening portion is a stud.

14. The motor structure of claim 1, wherein the first fastening portion is a stud and the second fastening portion is a hole.

15. A fan, comprising:
a fan blade element with a plurality of blades; and
a motor structure comprising:
a shaft;
a motor control panel comprising a first fastening portion and configured for coupled to receive a power source;
a stator engageable with the shaft and comprising:
a base body engageable with the shaft and comprising a plurality of excitation units; and
a fastening base disposed on a side of the base body facing the motor control panel, comprising a second fastening portion corresponding in position to the first fastening portion, wherein the second fastening portion is couple with the first fastening portion, so as to disposed the motor control panel to the stator;
a rotor corresponding in position to the stator and pivotally connected to the shaft and connected to the fan blade element, the rotor having a predetermined number of magnet units corresponding in number to the excitation units; and
a motor housing pivotally connected to the shaft and enclosing the shaft, the motor control panel, the stator, and the rotor;
wherein, upon connection with a power source, the motor control panel distributes electric power to each of the excitation units, allowing the each of the excitation units to generate an induced magnetic field for creating attraction and repulsion relative to the magnet units, thereby allowing the rotor to drive the fan blade element to rotate.

16. The fan of claim 15, wherein the base body of the stator is formed by stacking and series-connecting a plurality of metal sheets.

17. The fan of claim 16, wherein the metal sheets are silicon steel sheets.

18. The fan of claim 15, wherein the excitation units are coils.

19. The fan of claim 15, wherein the rotor further comprises a fastening frame disposed inside the motor housing and having an inner wall and an outer wall, the inner wall encircling a periphery of the stator, and the magnet units being disposed on the outer wall.

20. The fan of claim 15, wherein the motor control panel further comprises a sensor element, and the magnet units disposed on the outer wall of the fastening frame are of sizes, shapes, and positions allowing the magnet units to be sensed by the sensor element.

21. The fan of claim 20, wherein the sensor element is a Hall element.

22. The fan of claim 15, wherein the magnet units are permanent magnets.

23. The fan of claim 15, wherein the motor structure further comprises a shield plate disposed between the motor control panel and the stator for shielding magnetic fields generated by the excitation units and isolating high voltage.

24. The fan of claim 15, wherein the first fastening portion is a hole and the second fastening portion is a stud.

25. The fan of claim 15, wherein the first fastening portion is a stud and the second fastening portion is a hole.
